(19) United States
(12) Patent Application Publication
(10) Pub. No.: US 2021/0148370 A1
(43) Pub. Date: May 20, 2021

(54) LONG LIFE FAN

(71) Applicant: CHAMP TECH OPTICAL (FOSHAN) CORPORATION, Foshan (CN)

(72) Inventors: YUNG-PING LIN, New Taipei (TW); YONG-KANG ZHANG, Foshan (CN); HUNG-SHIUO HAN, New Taipei (TW); DONG-MING PAN, Foshan (CN)

(21) Appl. No.: 16/734,436

(22) Filed: Jan. 6, 2020

(30) Foreign Application Priority Data
Nov. 18, 2019 (CN) 201911124967.X

(51) Int. Cl. F04D 25/02; H02K 7/08; H02K 11/00; H02K 7/14; F04D 29/26

(52) U.S. Cl. CPC F04D 25/026; H02K 7/085; H02K 2211/03; H02K 7/14; F04D 29/263; H02K 11/0094

(57) ABSTRACT

A fan with reduced friction and subject to much reduced wear includes a stator assembly and a rotating assembly. The stator assembly includes a base, a fixing shaft, and a stator. The fixing shaft is positioned at the base. The stator is positioned outside the fixing shaft. The rotating assembly includes a rotor, a bearing, and a magnetic member. The bearing is sleeved on the fixing shaft. The magnetic member is positioned on an inner wall of the rotor and is spaced apart from the stator. The magnetic member generates a magnetic force with the stator to drive the bearing to rotate around the fixing shaft while the bearing is not in any contact with the base and the stator.

### FIELD

The subject matter herein generally relates to fans, and in particular to a fan with a longer life.

### BACKGROUND

Generally, a fan includes a base, a bearing, a fixing shaft, and a rotor. The bearing is installed on the base and the fixing shaft is fixed on the rotor. When the fan is running, the bearing keeps still and the fixing shaft rotates with the rotor. In this way, during the operation of the fan, the fan may not have a long life because a contact friction loss occurs when the bearing rotates around the fixing shaft.

Therefore, there is room for improvement within the art.

### BRIEF DESCRIPTION OF THE DRAWINGS

Many aspects of the disclosure can be better understood with reference to the figure. The components in the figures are not necessarily drawn to scale, the emphasis instead being placed upon clearly illustrating the principles of the disclosure.

FIG. 1 is an isometric view of an assembled fan according to a first embodiment of the present disclosure.

FIG. 2 is a cross-sectional view taken along line II-II of FIG. 1.

FIG. 3 is a cross-sectional view of an assembled fan according to a second embodiment of the present disclosure.

FIG. 4 is a cross-sectional view of an assembled fan according to a third embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

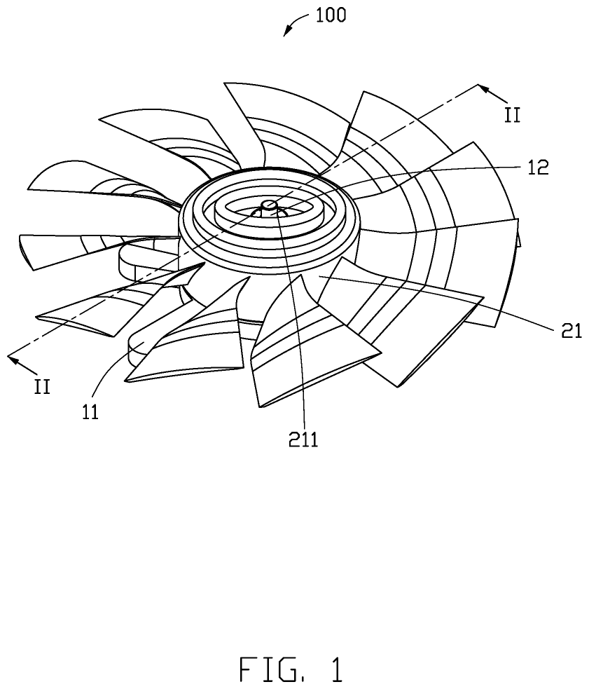

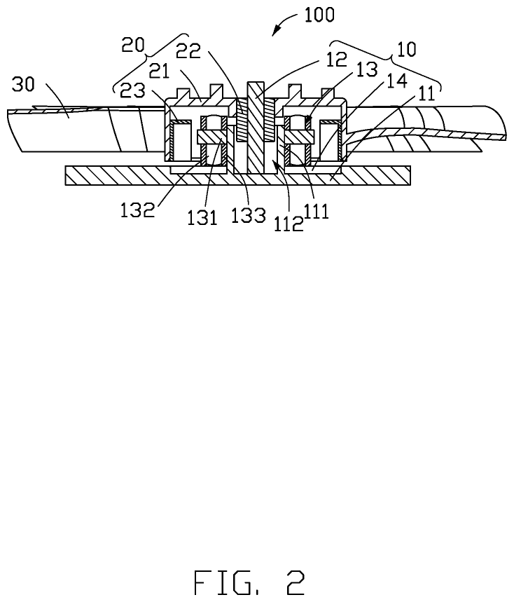

FIG. 1 and FIG. 2 illustrate a fan 100. The fan 100 includes a stator assembly 10, a rotating assembly 20, and at least one fan blade 30. The rotating assembly 20 is sleeved on the stator assembly 10. The at least one fan blade 30 is positioned on the rotating assembly 20. When the fan 100 is running, the stator assembly 10 remains stationary, and the rotating assembly 20 drives the at least one fan blade 30 to rotate around the stator assembly 10. At this time, the rotating assembly 20 is not in contact with the stator assembly 10 or is only in partial contact with the stator assembly 10. When the fan 100 is stationary, the rotating assembly 20 and the stator assembly 10 are in partial contact.

As illustrated in FIG. 2, in this embodiment, the stator assembly 10 includes a base 11, a fixing shaft 12, a stator 13, and a circuit board 14. The base 11 is configured to carry and support components of the fan 100. The base 11 can be made of plastic, non-magnetic material, metal, alloy, or other materials. The base 11 includes a shaft tube 111. The shaft tube 111 is substantially positioned at a central position of the base 11 and defines an opening 112. The shaft tube 111 may be integrally formed with the base 11, or separately provided. In this embodiment, the shaft tube 111 can be a steel pipe.

The fixing shaft 12 is positioned at a center of the shaft tube 111. The fixing shaft 12 is configured to carry and support the rotating assembly 20. When the fan 100 is running, the fixing shaft center 12 remains stationary. In this embodiment, the fixing shaft 12 can be fixed at the center of the shaft tube 111 by means of clamping, adhesion, integral molding, fitting, clamping, or the like.

The stator 13 is positioned outside the shaft tube 111. The stator 13 can be a magnetic dipole. The stator 13 is configured to drive the rotating assembly 20 to rotate. In this embodiment, the stator 13 includes a magnetically conductive sheet 131, a coil 132, and an insulation frame 133.

The magnetically conductive sheet 131 is magnetic. For example, when encountering a magnet, the magnetically conductive sheet 131 and the magnet will attract each other. In this embodiment, the magnetically conductive sheet 131 has a circular shape. The magnetically conductive sheet 131 is positioned outside the coil 132. In this embodiment, the magnetically conductive sheet 131 may be a silicon steel sheet or other element having magnetism.

The coil 132 is wound on the insulation frame 133. A material of the coil 132 may be metal, alloy, or other conductive materials. In one embodiment, the coil 132 may be axially or radially wound on the insulation frame 133, or in other manner.

In this embodiment, the circuit board 14 is positioned below the stator 13. The circuit board 14 is electrically connected to the coil 132 to control an operation of the fan 100.

The rotating assembly 20 includes a rotor 21, a bearing 22, and a magnetic member 23.

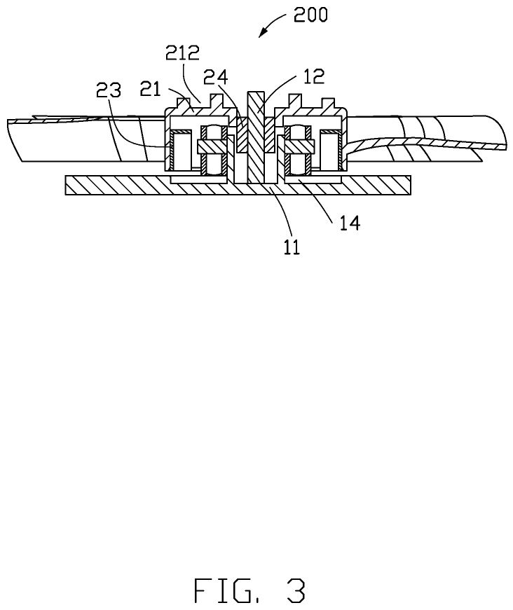

The rotor 21 is a casing with one end defining an opening. The rotor 21 is substantially in a cylindrical shape. One end of the rotor 21 defines a through hole 211 (shown in FIG. 1). The through hole 211 corresponds to the fixing shaft 12. By aligning the through hole 211 with the fixing shaft 12, the fixing shaft 12 can pass through the through hole 211. Then the rotor 21 is sleeved on the stator assembly 10 and covers the stator 13 and the circuit board 14. In one embodiment, an upper surface of the rotor 21 defines a groove 212 (shown in FIG. 3). The groove 212 is uneven or stepped and is configured for preventing ingress of dust.

In this embodiment, the bearing 22 is a sleeve bearing. A size of the bearing 22 is smaller than that of the through hole 211. The bearing 22 is sleeved on the fixing shaft 12 and has no contact with an inner wall of the through hole 211. That is, the bearing 22 is spaced apart from the inner wall of the through hole 211. When the bearing 22 is sleeved on the fixing shaft 12, one end of the bearing 22 adjacent to the base 11 extends into the shaft tube 111 and is spaced apart from a peripheral wall of the shaft tube 111. That is, the bearing 22 is not in contact with the peripheral wall of the shaft tube 111. In one embodiment, the bearing 22 is, for example, an oil-containing bearing.

The magnetic member 23 is positioned on an inner wall of the rotor 21. The magnetic member 23 is spaced apart from the stator 13. The magnetic member 23 is flexible, and can be folded and bent without damaging its magnetic properties. In this embodiment, the magnetic member 23 is a gel magnet. The gel magnet is made of synthetic rubber or plastic mixed magnetic powder.

In this embodiment, the fan blades 30 are positioned at a surface of the rotor 21 and radiate outward. In this embodiment, the fan blades 30 may be centrifugal fan blades, flat fan blades, axial fan blades, or other types of fan blades.

In this embodiment, when the coil 132 is energized under a control of the circuit board 14, a current passes through the coil 132, electromagnetic induction occurs, and a magnetic field is induced. The induced magnetic field interacts with the magnetic member 23 and produces magnetic repulsion, thereby driving the magnetic member 23 to operate. Since the magnetic member 23 is fixed to the inner wall of the rotor 21, the coil 132 drives the rotor 21, the bearing 22, and the fan blades 30 to rotate around the stator assembly 10.

At the same time, because the magnetically conductive sheet 131 is magnetic, the magnetically conductive sheet 131 will generate a magnetic force with the magnetic member 23. As a result, under the control of the magnetic force, the bearing 22 sleeved on the fixing shaft 12 will follow the rotating assembly 20 to operate in a physically suspended state because of the magnetic repulsion. In this embodiment, the suspended state means that the bearing 22 does not contact with the base 11 during rotation, and the fixing shaft 12 remains stationary because the fixing shaft 12 is fixed on the base 11.

Specifically, when the fan 100 is running, the magnetic member 23 and the magnetically conductive sheet 131 are attracted to each other by magnetic force, so that the rotating assembly 20 is magnetically suspended above the stator assembly 10. That is, the bearing 22 is suspended above the base 11 without contacting the base 11 and the stator 13, so as to reduce friction and contact loss of the bearing 22, the base 11, and the stator 13.

In other embodiments, the bearing 22 is not limited to an oil-containing bearing, and it may also be other type of bearing. For example, referring to FIG. 3, a bearing 24 may be a single ball bearing. The bearing 24 is fixed on the rotor 21 and is sleeved on the fixing shaft 12. When a fan 200 is running, the fixing shaft 12 does not rotate because it is fixed on the base 11, and the bearing 24 rotates with the rotor 21.

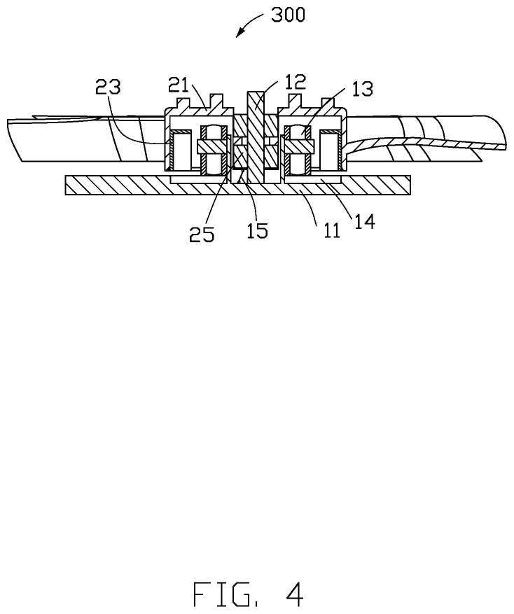

As illustrated in FIG. 4, in other embodiments, a bearing 25 may be a double ball bearing. The bearing 25 is fixed on the rotor 21. A spring 15 is also provided. One end of the spring 15 is positioned on the base 11, and another end of the spring 15 is connected to the bearing 25 for supporting the rotation of the bearing 25. When a fan 300 is running, the fixing shaft 12 does not rotate because it is fixed on the base 11, and the bearing 25 rotates with the rotor 21.

The fan 100/200/300 generates magnetic force through the magnetic member 23 and the magnetically conductive sheet 131. The rotor 21 runs without contacting the base 11, and the bearing 22 is rotated around the fixing shaft 12 under the magnetic suspension. Under this condition, the bearing 22 is only in partial contact with the fixing shaft 12 and does not contact other components of the stator assembly 10. The friction and contact loss of the bearing 22 is reduced when the fan 100 is running, thereby ensuring a reliability and effectively extending the life of the fan 100/200/300.

It is believed that the embodiments and their advantages will be understood from the foregoing description, and it will be apparent that various changes may be made thereto without departing from the scope of the disclosure or sacrificing all of its advantages, the examples hereinbefore described merely being illustrative embodiments of the disclosure.

What is claimed is:

1. A fan, the fan comprising:
a stator assembly, the stator assembly comprising a base, a fixing shaft, and a stator, the fixing shaft positioned at the base, the stator positioned outside the fixing shaft;
a rotating assembly, the rotating assembly comprising a rotor, a bearing, and a magnetic member, the bearing sleeved on the fixing shaft, the magnetic member positioned on an inner wall of the rotor and spaced apart from the stator; and
wherein the magnetic member generates a magnetic force with the stator to drive the bearing to rotate around the fixing shaft while the bearing is not in any contact with the base and the stator.

2. The fan of claim 1, wherein the magnetic member is a gel magnet.

3. The fan of claim 1, wherein the bearing is one of an oil-containing bearing, a single ball bearing, and a double ball bearing.

4. The fan of claim 3, wherein when the bearing is a double ball bearing, the stator assembly further comprises a spring, one end of the spring is positioned on the base, and another end of the spring is connected to the double ball bearing for supporting the rotation of the double ball bearing on the rotor.

5. The fan of claim 1, wherein the stator comprises a magnetically conductive sheet, the magnetically conductive sheet corresponds to the magnetic member, the magnetically conductive sheet is magnetic, the magnetically conductive sheet and the magnetic member cooperatively generates the magnetic force.

6. The fan of claim 5, wherein the magnetically conductive sheet is a silicon steel sheet.

7. The fan of claim 5, further comprising a circuit board, wherein the stator further comprises a coil and an insulation frame, the circuit board is positioned below the stator, the coil is positioned to surround the insulation frame, the circuit board is electrically connected to the coil for driving the rotating assembly to rotate.

8. The fan of claim 7, wherein when the coil is energized under a control of the circuit board, a current passes through the coil, electromagnetic induction occurs, and a magnetic field is induced, the induced magnetic field drives the rotating assembly to rotate, under a control of the magnetic force, the magnetic member and the magnetically conductive sheet control the bearing to be suspended above the base without contacting the base.

9. A fan, the fan comprising:
a stator assembly, the stator assembly comprising a base, a fixing shaft, and a stator, the fixing shaft positioned at the base, the stator positioned outside the fixing shaft;
a rotating assembly, the rotating assembly comprising a rotor, a bearing, and a magnetic member, the bearing positioned sleeved on the fixing shaft, the magnetic member positioned on an inner wall of the rotor and spaced apart from the stator;
at least one fan blade, the at least one fan blade fixed on the rotating assembly; and
wherein the magnetic member generates a magnetic force with the stator to drive the bearing to rotate around the fixing shaft, the at least one fan blade rotates along with the stator, while the bearing is not in any contact with the base and the stator.

10. The fan of claim 11, wherein the at least one fan is one of centrifugal fan blades, flat fan blades, and axial fan blades.

11. The fan of claim 9, wherein the magnetic member is a gel magnet.

12. The fan of claim 9, wherein the bearing is one of an oil-containing bearing, a single ball bearing, and a double ball bearing.

13. The fan of claim 12, wherein when the bearing is a double ball bearing, the stator assembly further comprises a spring, one end of the spring is positioned on the base, and another end of the spring is connected to the double ball bearing for supporting the rotation of the double ball bearing on the rotor.

14. The fan of claim 9, wherein the stator comprises a magnetically conductive sheet, the magnetically conductive sheet corresponds to the magnetic member, the magnetically conductive sheet is magnetic, the magnetically conductive sheet and the magnetic member cooperatively generates the magnetic force.

15. The fan of claim 14, wherein the magnetically conductive sheet is a silicon steel sheet.

16. The fan of claim 14, further comprising a circuit board, wherein the stator further comprises a coil and an insulation frame, the circuit board is positioned below the stator, the coil is positioned to surround the insulation frame, the circuit board is electrically connected to the coil for driving the rotating assembly to rotate.

17. The fan of claim 16, wherein when the coil is energized under a control of the circuit board, a current passes through the coil, electromagnetic induction occurs, and a magnetic field is induced, the induced magnetic field drives the rotating assembly to rotate, under a control of the magnetic force, the magnetic member and the magnetically conductive sheet control the bearing to be suspended above the base without contacting the base.
